(19) United States
(12) Patent Application Publication
(10) Pub. No.: US 2016/0230569 A1
(43) Pub. Date: Aug. 11, 2016

(54) CMC AIRFOIL WITH SHARP TRAILING EDGE AND METHOD OF MAKING SAME

(71) Applicant: UNITED TECHNOLOGIES CORPORATION, Hartford, CT (US)

(72) Inventors: Shelton O. Duelm, Wethersfield, CT (US); Michael G. McCaffrey, Windsor, CT (US)

(21) Appl. No.: 15/022,631

(22) PCT Filed: Sep. 15, 2014
(86) PCT No.: PCT/US2014/055543

§ 371 Date: Mar. 17, 2016

Related U.S. Application Data
(60) Provisional application No. 61/881,121, filed on Sep. 23, 2013.

(51) Int. Cl. F01D 5/28; F01D 5/14

(52) U.S. Cl. CPC F01D 5/282; F01D 5/284; F01D 5/147; F05D 2300/6033; F05D 2240/122

(57) ABSTRACT

An airfoil component includes an insert that has angled faces joined at an edge that provides an airfoil trailing edge. An outer CMC fiber layer overlaps the angled faces to provide a trailing edge portion of an airfoil.

### CROSS-REFERENCE TO RELATED APPLICATIONS

This application claims priority to U.S. Provisional Application No. 61/881,121, which was filed on Sep. 23, 2013 and is incorporated herein by reference.

### BACKGROUND

This disclosure relates to a gas turbine engine, and, more particularly, to composite airfoil components, such as vanes or blades.

Gas turbine engines typically include a compressor section, a combustor section and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads.

Both the compressor and turbine sections may include alternating series of rotating blades and stationary vanes that extend into the core flow path of the gas turbine engine. For example, in the turbine section, turbine blades rotate and extract energy from the hot combustion gases that are communicated along the core flow path of the gas turbine engine. The turbine vanes, which generally do not rotate, guide the airflow and prepare it for the next set of blades.

The turbine section of the engine experiences high temperatures, which can limit the life of hot section components, such as vanes and blades. One type of turbine vane is constructed from a composite material, which is difficult to manufacture.

Aerodynamic performance is dependent on a sharp airfoil trailing edge radius. Typically, ceramic composite materials, such as ceramic matrix composites (CMC), are too stiff to wrap around the trailing edge radius without breaking fibers which damages the material and creates a rough surface finish and thicker trailing edge. So, instead the free ends of the layers are joined to one another at the trailing edge. Machining the CMC to the desired radius can also be extremely costly and time-consuming due to the hardness of the CMC material.

### SUMMARY

In one exemplary embodiment, an airfoil component includes an insert that has angled faces joined at an edge that provides an airfoil trailing edge. An outer CMC fiber layer overlaps the angled faces to provide a trailing edge portion of an airfoil.

In a further embodiment of the above, the insert is ceramic.

In a further embodiment of any of the above, the outer CMC layer provides a pressure side and a suction side.

In a further embodiment of any of the above, an inner CMC fiber layer provides an internal cavity to the airfoil.

In a further embodiment of any of the above, the inner CMC fiber layer adjoins and provides backing to an inner face of the insert that joins the angled faces.

In a further embodiment of any of the above, voids are provided between the inner CMC fiber layer and the insert. The voids are filled with a ceramic-based resin.

In a further embodiment of any of the above, the inner CMC fiber layer includes multiple plies.

In a further embodiment of any of the above, the outer CMC fiber layer includes multiple plies.

In a further embodiment of any of the above, the outer CMC fiber layer wraps about the edge such that the insert does not provide an exterior airfoil surface.

In a further embodiment of any of the above, the outer CMC fiber layer overlaps the insert and provides a free end that is short of and spaced from the edge such that a portion of the insert provides the exterior airfoil surface.

In another exemplary embodiment, an airfoil component includes an inner CMC fiber layer that provides an internal cavity to the airfoil. An insert that has angled faces is joined at an edge that provides an airfoil trailing edge. The inner CMC fiber layer adjoins and provides backing to an inner face of the insert that joins the angled faces. An outer CMC fiber layer overlaps the angled faces to provide a trailing edge portion of an airfoil. The outer CMC fiber layer includes multiple plies and provides a pressure side and a suction side.

In a further embodiment of any of the above, the insert in ceramic.

In a further embodiment of any of the above, voids are provided between the inner CMC fiber layer and the insert. The voids are filled with a ceramic-based resin.

In a further embodiment of any of the above, the outer CMC fiber layer wraps about the edge such that the insert does not provide an exterior airfoil surface.

In a further embodiment of any of the above, the outer CMC fiber layer overlaps the insert and provides a free end that is short of and spaced from the edge such that a portion of the insert provides the exterior airfoil surface.

In a further embodiment of any of the above, an airfoil component includes the steps of overlapping a CMC fiber layer over angled faces of an insert to provide to trailing edge portion of an exterior airfoil surface.

In a further embodiment of any of the above, the insert is at least one of a monolithic ceramic and chopped ceramic fibers with resin.

In a further embodiment of any of the above, an airfoil component includes the steps of machining an edge of the ceramic insert joining the angled faces.

In a further embodiment of any of the above, the outer CMC fiber layer wraps about the edge such that the insert does not provide an exterior airfoil surface.

In a further embodiment of any of the above, the outer CMC fiber layer overlaps the insert and provides a free end that is short of and spaced from the edge such that a portion of the insert provides the exterior airfoil surface.

### BRIEF DESCRIPTION OF THE DRAWINGS

The disclosure can be further understood by reference to the following detailed description when considered in connection with the accompanying drawings wherein:

FIG. 1 schematically illustrates vane.

FIG. 2 is a cross-sectional view through the vane shown in FIG. 1 taken along line 2-2.

FIG. 3 is an enlarged cross-sectional view of a trailing edge portion depicted in FIG. 2.

FIG. 4 is another example trailing edge portion cross-section.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

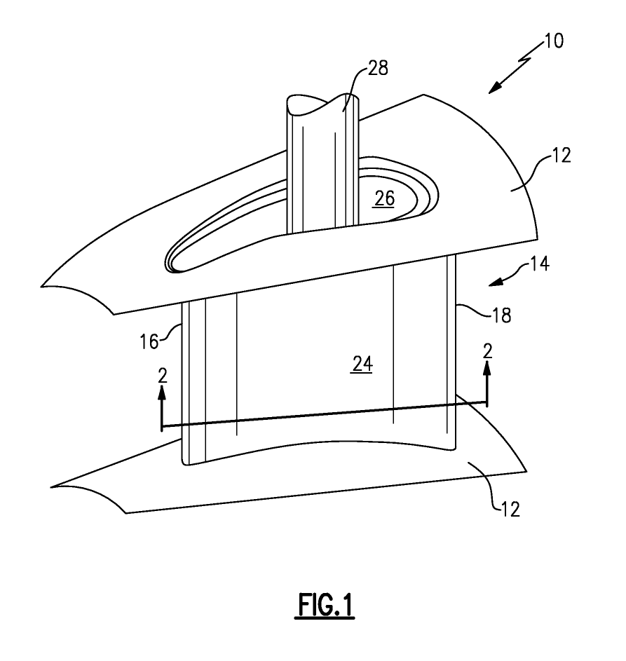

An airfoil component 10, such as a vane, is shown in FIG. 1. The component 10 includes an airfoil 14 extending in a radial direction from a platform 12. The airfoil 14 includes an exterior airfoil surface 24 having pressure and suction sides 20, 22 that are adjoin one another at leading and trailing edges 16, 18. It is desirable for the trailing edge 18 to have a relatively sharp radius for desired aerodynamic performance.

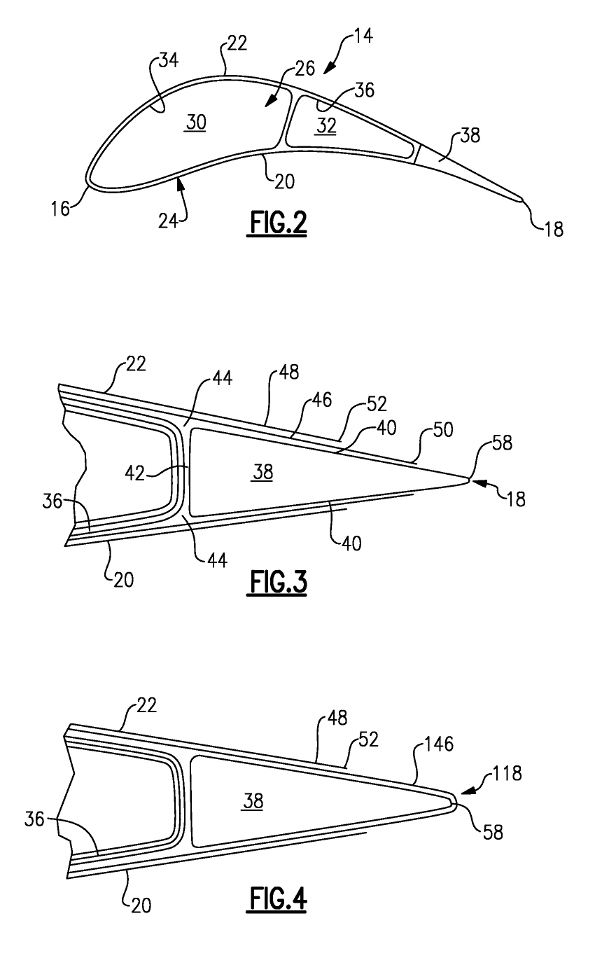

In the example of the airfoil component 10 being a vane, it may be desirable to provide a cavity 26 the radial length of the component to permit other components 28, such as wires and/or air or lubrication conduits, to pass through the cavity 26 from outside the engine to an interior of the engine. The cavity may be a single, large cavity as show at 26 in FIG. 1, or the cavity 26 may be bifurcated as shown in FIG. 2. It should be understood that the airfoil component may also be a blade.

An example cross-section of the airfoil 14 is shown in FIG. 2. In the example, the cavity 26 is provided by a first and second cavities 30, 32, respectively provided by first and second wrapped inner CMC fiber layers 34, 36. The inner CMC fiber layers 34, 36 may each be provided by multiple plies.

A ceramic insert 38 is provided at the trailing edge portion of the airfoil 14 to provide the trailing edge 18. In one example, the ceramic insert is provided by a monolithic ceramic or chopped CMC fibers with resin.

Referring to FIG. 3, an example trailing edge configuration is shown. The ceramic insert 38 includes angled faces 40 extending from an inner face 42 toward one another to an edge 58, which provides the trailing edge 18. In this example, the ceramic insert provides a generally triangular shape when viewed in cross-section as shown. The edge 58 can be molded to provide the desired radius or machined.

In the example, the inner CMC fiber layer 36 is adjacent to and backs the inner face 42 of the insert 38 to provide stability. Due to the difficulty of providing sharp edges with the inner CMC fiber layer 36, voids 44 may result between the inner CMC fiber layer 36 and the inner face 42, which can be filled with a filler. The filler may be constructed from any suitable material, such as stacked fibers, unidirectional material, laid up fabric, chopped fibers, a monolithic structure, resin or any other suitable material in configuration that it conforms to the voids 44.

A first layer 46, which may be provided by multiple plys, is laid over the angled faces 40. A free end 50 of the first layer 46 is arranged short of or spaced from the edge 58, such that at least a portion of the angled faces 40 are exposed to provide a portion of the exterior airfoil surface 24. Additional layers 48 may be laid over the first layer 46. In this example a second layer 48 includes a second free ends 52 that are also short of the edge 58. The second free ends 52 may be short of the first free ends 50 to provide additional taper at the trailing edge portion.

Referring to FIG. 4, another example trailing edge configuration is shown. An example, the first layer 146 may be wrapped about the edge 58 so that the insert 38 is not exposed and does not provide the exterior airfoil surface 24.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although example embodiments have been disclosed, a worker of ordinary skill in this art would recognize that certain modifications would come within the scope of the claims. For that and other reasons, the following claims should be studied to determine their true scope and content.

What is claimed is:

1. An airfoil component comprising:
an insert having angled faces joined at an edge that provides an airfoil trailing edge; and
an outer CMC fiber layer overlapping the angled faces to provide a trailing edge portion of an airfoil.

2. The airfoil component according to claim 1, wherein the insert is ceramic.

3. The airfoil component according to claim 1, wherein the outer CMC layer provides a pressure side and a suction side.

4. The airfoil component according to claim 1, comprising an inner CMC fiber layer providing an internal cavity to the airfoil.

5. The airfoil component according to claim 4, wherein the inner CMC fiber layer adjoins and provides backing to an inner face of the insert that joins the angled faces.

6. The airfoil component according to claim 5, comprising voids provided between the inner CMC fiber layer and the insert, and the voids are filled with a ceramic-based resin.

7. The airfoil component according to claim 4, wherein the inner CMC fiber layer includes multiple plies.

8. The airfoil component according to claim 1, wherein the outer CMC fiber layer includes multiple plies.

9. The airfoil component according to claim 8, wherein the outer CMC fiber layer wraps about the edge such that the insert does not provide an exterior airfoil surface.

10. The airfoil component according to claim 8, wherein the outer CMC fiber layer overlaps the insert and provides a free end that is short of and spaced from the edge such that a portion of the insert provides the exterior airfoil surface.

11. An airfoil component comprising:
an inner CMC fiber layer providing an internal cavity to the airfoil;
an insert having angled faces joined at an edge that provides an airfoil trailing edge, the inner CMC fiber layer adjoins and provides backing to an inner face of the insert that joins the angled faces; and
an outer CMC fiber layer overlapping the angled faces to provide a trailing edge portion of an airfoil, the outer CMC fiber layer includes multiple plies and provides a pressure side and a suction side.

12. The airfoil component according to claim 11, wherein the insert in ceramic.

13. The airfoil component according to claim 11, comprising voids provided between the inner CMC fiber layer and the insert, and the voids are filled with a ceramic-based resin.

14. The airfoil component according to claim 11, wherein the outer CMC fiber layer wraps about the edge such that the insert does not provide an exterior airfoil surface.

15. The airfoil component according to claim 11, wherein the outer CMC fiber layer overlaps the insert and provides a free end that is short of and spaced from the edge such that a portion of the insert provides the exterior airfoil surface.

16. The method of manufacturing an airfoil component comprising the steps of:
overlapping a CMC fiber layer over angled faces of an insert to provide to trailing edge portion of an exterior airfoil surface.

17. The method according to claim 16, wherein the insert is at least one of a monolithic ceramic and chopped ceramic fibers with resin.

18. The method according to claim 16, comprising the step of machining an edge of the ceramic insert joining the angled faces.

19. The method according to claim 16, wherein the outer CMC fiber layer wraps about the edge such that the insert does not provide an exterior airfoil surface.

20. The method according to claim 16, wherein the outer CMC fiber layer overlaps the insert and provides a free end that is short of and spaced from the edge such that a portion of the insert provides the exterior airfoil surface.
